(19) United States
(12) Patent Application Publication
(10) Pub. No.: US 2025/0386964 A1
(43) Pub. Date: Dec. 25, 2025

(54) Heat-dissipating thermostatic coffee pot

(71) Applicant: ZHEJIANG CHUANGJIAN KITCHENWARE CO., LTD., Quzhou (CN)

(72) Inventor: Liansheng HU, Quzhou (CN)

(73) Assignee: ZHEJIANG CHUANGJIAN KITCHENWARE CO., LTD., Quzhou (CN)

(21) Appl. No.: 18/881,448

(22) PCT Filed: Jul. 20, 2022
(86) PCT No.: PCT/CN2022/106651

§ 371 Date: Jan. 6, 2025

(30) Foreign Application Priority Data
Jul. 8, 2022 (CN) 202210797628.3

(51) Int. Cl. A47J 31/30; A47G 19/14; A47J 31/44; A47J 31/58

(52) U.S. Cl. CPC A47J 31/303; A47G 19/14; A47J 31/4403; A47J 31/58; A47J 2201/00

(57) ABSTRACT

A heat-dissipating thermostatic coffee pot comprising an upper pot, a coffee powder hopper, a lower pot and a water suction hopper, wherein a heat-dissipating thermostat is provided between the upper pot and the lower pot, the heat-dissipating thermostat comprising a main body, at least one deflector hole and at least one heat-dissipating groove; the main body is provided with an upper connecting end and a lower connecting end, which are connected to the upper pot and the lower pot, respectively; the deflector hole adopt a through hole passing through an upper end and a lower end of the main body; the heat-dissipating groove is arranged on a side of the main body and is placed on an outer periphery of the deflector hole; a conducting water flow path is formed between the lower pot, the water suction hopper, the deflector hole, the coffee powder hopper and the upper pot.

### TECHNICAL FIELD

The present invention relates to the technical field of moka pots, in particular, to a heat-dissipating thermostatic coffee pot.

### BACKGROUND TECHNOLOGY

A moka pot is divided into an upper structure, a middle structure and a lower structure, with a lower pot being a water tank, the middle powder hopper holding coffee powder, and an upper pot holding extracted coffee liquid, which works by heating water in the lower pot and turning the water into vapor, using vapor pressure to push the water up through conduits into the powder hopper to extract coffee liquid, and then continuing to push the coffee liquid up through the conduits to the upper pot to polymerize and flow out.

Currently, there are two types of moka pots on the market: single-valve moka pots and double-valve moka pots. Extraction pressure of the single-valve moka pots is about 0.1 Mpa, which cannot completely extract coffee liquid. Lifting pressure of the double-valve moka pots is between 0.25-0.35 Mpa, which can be referred to a patent titled “Pressure Valve of a Moka Pot” with publication number CN201821465085, published on Nov. 22, 2019. The double-valve moka pot can effectively facilitate extraction of coffee, making coffee rich in oil, but a disadvantage of increasing pressure is that heating time also increases accordingly, which is prone to lead to coffee splashing and over-extraction. Too long heating time leads to too high water temperature, which will cause a series of problems such as secondary boiling in the upper pot and burning taste. Optimal water temperature of coffee extraction is 90 degrees Celsius.

### SUMMARY OF THE INVENTION

For solving the above existing problems of the prior art, the present invention provides a heat-dissipating thermostatic coffee pot, which dissipates heat before extracting coffee with hot water to keep water temperature well suited for extraction.

In order to achieve the above object, the technical solution adopted by the present invention is as follows: The present invention provides a heat-dissipating thermostatic coffee pot comprising an upper pot, a coffee powder hopper arranged in the upper pot, a lower pot and a water suction hopper arranged in the lower pot, wherein a heat-dissipating thermostat is provided between the upper pot and the lower pot, the heat-dissipating thermostat comprising a main body, at least one deflector hole and at least one heat-dissipating groove; the main body is provided with an upper connecting end and a lower connecting end, which are connected to the upper pot and the lower pot, respectively; the deflector hole adopt a through hole passing through an upper end and a lower end of the main body; the heat-dissipating groove is arranged on a side of the main body and is placed on an outer periphery of the deflector hole; a conducting water flow path is formed between the lower pot, the water suction hopper, the deflector hole, the coffee powder hopper and the upper pot.

A beneficial effect of adopting the above technical solution is: The heat-dissipating thermostat is provided between the upper pot and lower pot of an existing coffee pot, so that hot water enters the main body of the heat-dissipating thermostat through the deflector hole before the hot water enters the coffee powder hopper from the lower pot. Since the heat-dissipating thermostat is provided with the heat-dissipating groove, contact surfaces between the main body of the heat-dissipating thermostat and air are increased due to provision of the heat-dissipating groove, so when the hot water passes through the deflector hole, heat is conducted from an inner side of the main body to an outer side of the main body, with external air convectively exchanging heat with the outer side of the main body, thus dissipating the hot water to avoid splatter and over-extraction of coffee liquid, keeping the water temperature with a good extraction temperature, and maintaining stable water pressure.

Further, the heat-dissipating thermostatic coffee pot is configured with a plurality of deflector holes circumferentially distributed around a center of the main body and heat-dissipating grooves provided on the side of the main body corresponding to each deflector hole.

The beneficial effect of adopting the above technical solution is that the present invention allows a uniform diversion of the hot water and ensures uniform heat dissipation of water to reach a desired temperature.

Further, the deflector holes are 3 in number and are distributed at a spacing of 120 degrees along the center of the main body, and the heat-dissipating grooves are 3 in number with each corresponding to the to 3 deflector holes provided on the side of the main body.

The beneficial effect of adopting the above technical solution is that the number of deflector holes can be set based on a size of the coffee pot, and 3 pairs of the deflector holes and the heat-dissipating grooves are preferred in the present invention.

Further, each of the deflector holes is provided with a plurality of heat-dissipating grooves arranged in parallel on the side of the main body.

The beneficial effect of adopting the above technical solution is that each deflector hole can either be provided with a heat-dissipating groove, or a plurality of heat-dissipating grooves can be provided in a same vertical plane to dissipate heat to the deflector hole, which can be set according to an actual situation.

Further, the heat-dissipating grooves extend from an outer peripheral end to the center of the main body, with diameters of the heat-dissipating grooves gradually decreasing from an outer end to an inner portion.

The beneficial effect of adopting the above technical solution is that a large diameter of the outer end facilitates air circulation and heat dissipation, and the diameter of the inner end contributes to maintain strength of the heat-dissipating thermostat itself.

Further, heights and the diameters of the heat-dissipating grooves are proportional to capacity of the lower pot.

The beneficial effect of adopting the above technical solution is that the heights and diameters of the heat-dissipating grooves can be adjusted according to the capacity of the coffee pot. Theoretically, the larger the heat-dissipating grooves, the better the heat dissipation effect, and an optimum size for maintaining the water temperature at 90 degrees Celsius can be selected through experimental testing.

Further, the upper pot comprises an upper pot body, an upper pot cover, a pressurizing valve cap, a pressurizing valve core and an upper pot handle; the center of the upper pot body being provided with at least one conduit communicating with a bottom, and the conduit being surrounded by a space for holding coffee liquid; the pressurizing valve core being mounted at a top outlet of the conduit and provided with a valve core sealing ring, and the pressurizing valve cap being installed on the pressurizing valve core; one end of the upper pot cover being fixed with at least one nylon cover cap, and an other end being hinged with the upper pot body through the nylon cover cap and pins; the upper pot handle being fixedly connected to one side of the upper pot body.

The beneficial effect of adopting the above technical solution is that the present invention adopts a double-valve structure, which can effectively promote the coffee extraction and make coffee rich in oil. The upper pot cover can be opened or closed by pressing the nylon cover cap, which is well insulated and also prevents hands from being burned. Similarly the upper pot handle is also made of nylon, which is not limited to nylon, and can be replaced with other suitable thermal insulation materials.

Further, the main body is cylindrical, an upper part of the main body is formed with an accommodating space, the coffee powder hopper is snapped in the accommodating space, a top of the coffee powder hopper is provided with a filter screen, the main body is threaded with the upper pot, and an upper sealing ring is installed between the main body and the upper pot; a thermostat handle is provided on the side of the main body.

The beneficial effect of adopting the above technical solution is that the coffee powder hopper is placed on the main body of the heat-dissipating thermostat, making an overall structure compact and a space layout reasonable. An upper part of the coffee powder hopper is equipped with the filter screen, which can prevent coffee powder from entering into the upper pot without being fully extracted. The thermostat handle is set up for easy gripping and is made of nylon, which provides good thermal insulation and prevents hands from being burned, and is not limited to a use of nylon material, but can be replaced with other suitable thermal insulation materials.

Further, the top of the water suction hopper is formed with two layers of walls, an outer hopper wall and an inner hopper wall, the outer hopper wall is provided with threads, the bottom of the main body is provided with peripheral lower threads and concave internal threads, the lower threads of the main body are connected with the lower pot, and the main body is connected with the water suction hopper through the internal threads; a sealing ring groove is formed between the lower threads and the internal threads, and a lower sealing ring is arranged in the sealing ring groove. The beneficial effect of adopting the above technical solution is that the water suction hopper has two layers of walls, forming a double-layer sealing structure, which strengthens sealing, and meanwhile achieves an excellent sealing effect by being equipped with the lower sealing ring.

Further, an inner portion of a lower pot body is used as a water holding tank, and a pot body is provided with a safety relief valve.

The beneficial effect of adopting the above technical solution is that the pressure inside the coffee pot can be safely relieved to ensure safety.

### BRIEF DESCRIPTION OF THE DRAWINGS

FIG. 1 is a schematic structural diagram of the present invention;

FIG. 2 is a perspective assembly view of the present invention;

FIG. 3 is a top view of a heat-dissipating thermostat of the present invention;

FIG. 4 is a bottom view of the heat-dissipating thermostat of the present invention;

FIG. 5 is a cross-sectional view of the heat-dissipating thermostat of the present invention;

FIG. 6 is a schematic view of a water suction hopper of the present invention;

FIG. 7 is a schematic diagram of a working principle of the present invention;

FIG. 8 (a) is a nephogram of water temperature at an outlet of the heat-dissipating thermostat at an ambient temperature of 25° C., and FIG. 8 (b) is a plot illustrating changes of average water temperature at the outlet over time;

The markups in the drawings are indicated as follows:

1—upper pot; 101—nylon cover cap; 102—upper pot cover; 103—pressurizing valve cap; 104—pressurizing valve core; 105—valve core seal ring; 106—pin; 107—upper pot handle; 108—upper pot body; 2—heat—dissipating thermostat; 201—thermostat handle; 202—main body; 203—heat—dissipating groove; 204—deflector hole; 205—accommodating space; 206—upper threads; 207—lower threads; 208—internal threads; 3—safety relief valve; 4—lower pot; 5—filter screen; 6—upper sealing ring; 7—coffee powder hopper; 8—lower sealing ring; 9—water suction hopper; 901—inner hopper wall; 902—outer hopper wall.

### SPECIFIC EMBODIMENTS

The present invention will be further described below with reference to the accompanying drawings.

The terms “up”, “down”, “front”, “back”, “left”, “right”, “vertical”, “horizontal”, “top”, “bottom”, “inner”, “outer”, “axial”, “radial”, “circumferential” and the like in the description, indicating orientations or positional relationships, are based on the orientations or positional relationships shown in the accompanying drawings, and are used only for the purpose of facilitating and simplifying the description and not necessarily for indicating or implying a specific orientation for the device or element referred to or that the device or element referred to is constructed and operated in a specific orientation, which is in no way intended to limit the technical solutions of the present invention.

In the description of the present disclosure, it should be noted that, unless otherwise clearly specified and limited, the terms “install/installs/installed/installing”, “connect/connects/connected/connecting” and “couple/couples/coupled/coupling” should be broadly understood. For example, it can be a fixed connection, a detachable connection, or an integral connection; it can be a mechanical connection or an electrical connection; it can be a direct connection or an indirect connection through an intermediate medium; it can also be the internal connection of two elements, it can be a wireless connection or a wired connection. To those skilled in the art, the specific meaning of the above terms in this disclosure may be understood in specific cases.

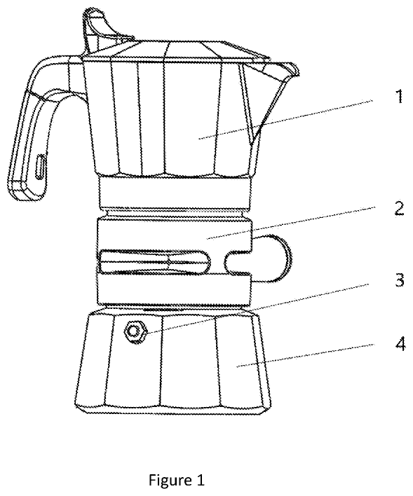

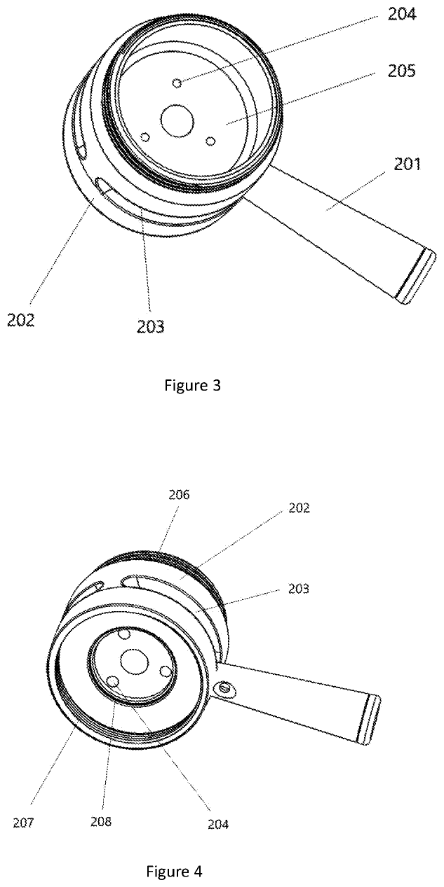

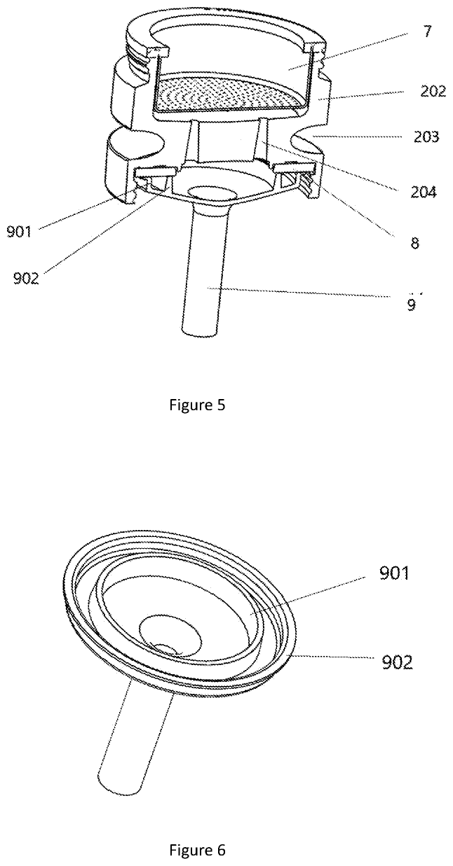

Referring to FIGS. 1 and 3, according to an embodiment of the present invention, the present invention provides a heat-dissipating thermostatic coffee pot comprising an upper pot 1, a coffee powder hopper 7 arranged in the upper pot 1, a lower pot 4 and a water suction hopper 9 arranged in the lower pot 4, wherein a heat-dissipating thermostat 2 is provided between the upper pot 1 and the lower pot 4, the heat-dissipating thermostat 2 comprising a main body 202, at least one deflector hole 204 and at least one heat-dissipating groove 203; the main body 202 is provided with an upper connecting end and a lower connecting end, which are connected to the upper pot 1 and the lower pot 4, respectively; the deflector hole 204 adopt a through hole passing through an upper end and a lower end of the main body 202; the heat-dissipating groove 203 is arranged on a side of the main body 202 and is placed on an outer periphery of the deflector hole 204; a conducting water flow path is formed between the lower pot 1, the water suction hopper 9, the deflector hole 204, the coffee powder hopper 7 and the upper pot 4. In the present invention, the heat-dissipating thermostat 2 is provided between the upper pot and lower pot of an existing coffee pot as shown in FIG. 5, so that when the coffee pot is heated, hot water enters the main body 202 of the heat-dissipating thermostat through the deflector hole 204 before the hot water enters the coffee powder hopper 7 from the lower pot 4. Since the heat-dissipating thermostat 203 is provided with the heat-dissipating groove 203, contact surfaces between the main body of the heat-dissipating thermostat and air are increased due to provision of the heat-dissipating groove 203, so when the hot water passes through the deflector hole 204, heat is conducted from an inner side of the main body to an outer side of the main body, with external air convectively exchanging heat with the outer side of the main body, thus dissipating the hot water to avoid splatter and over-extraction of coffee liquid, keeping the water temperature with a good extraction temperature, and maintaining stable water pressure.

According to some other specific embodiments of the present invention, other aspects are the same as the above embodiments, except that as shown in FIGS. 3 and 4, the heat-dissipating thermostatic coffee pot is configured with a plurality of deflector holes 204 circumferentially distributed around a center of the main body and heat-dissipating grooves 203 provided on the side of the main body corresponding to each deflector hole 204. In this embodiment, the present invention allows a uniform diversion of the hot water 4 and ensures uniform heat dissipation of water to reach a desired temperature.

In other specific embodiments of the present invention, other aspects are the same as the above embodiments, except that as shown in FIGS. 3 and 4, the deflector holes 204 are 3 in number and are distributed at a spacing of 120 degrees along the center of the main body, and the heat-dissipating grooves 203 are 3 in number with each corresponding to the to 3 deflector holes 204 provided on the side of the main body. The number of deflector holes 204 can be set based on a size of the coffee pot, and 3 pairs of the deflector holes and the heat-dissipating grooves are preferred in the present invention.

In other specific embodiments of the present invention, other aspects are the same as the above embodiments, except that as shown in FIG. 3, each of the deflector holes 204 is provided with a plurality of heat-dissipating grooves 203 arranged in parallel on the side of the main body. Each deflector hole 204 can either be provided with a heat-dissipating groove 203, or a plurality of heat-dissipating grooves can be provided in a same vertical plane to dissipate heat to the deflector hole, which can be set according to an actual situation.

In other specific embodiments of the present invention, other aspects are the same as the above embodiments, except that as shown in FIG. 1, the heat-dissipating grooves 203 extend from an outer peripheral end to the center of the main body, with diameters of the heat-dissipating grooves 203 gradually decreasing from an outer end to an inner portion. A large diameter of the outer end facilitates air circulation and heat dissipation, and the diameter of the inner end contributes to maintain strength of the heat-dissipating thermostat itself. Heights and the diameters of the heat-dissipating grooves are proportional to capacity of the lower pot. The heights and diameters of the heat-dissipating grooves 203 can be adjusted according to the capacity of the coffee pot. Theoretically, the larger the heat-dissipating grooves, the better the heat dissipation effect, and an optimum size for maintaining the water temperature at 90 degrees Celsius can be selected through experimental testing.

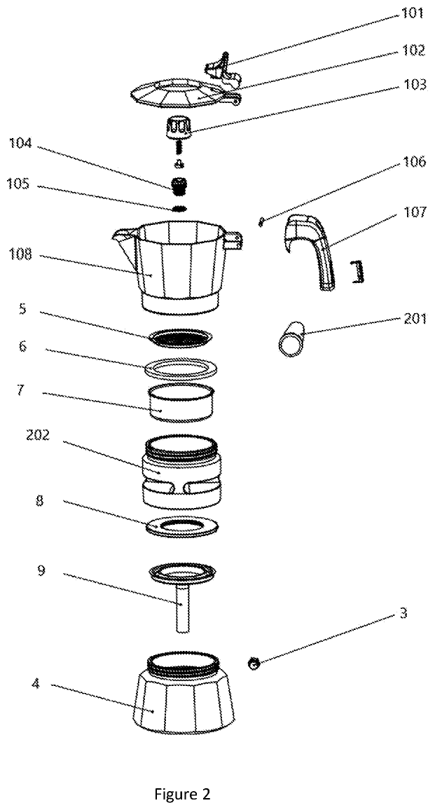

In other specific embodiments of the present invention, other aspects are the same as the above embodiments, except that as shown in FIG. 2, the upper pot 1 comprises an upper pot body 108, an upper pot cover 102, a pressurizing valve cap 103, a pressurizing valve core 104 and an upper pot handle 107; the center of the upper pot body 108 being provided with at least one conduit communicating with a bottom, and the conduit being surrounded by a space for holding coffee liquid; the pressurizing valve core 104 being mounted at a top outlet of the conduit and provided with a valve core sealing ring 105, and the pressurizing valve cap 103 being installed on the pressurizing valve core 104. The present invention adopts a double-valve structure, which can effectively promote the coffee extraction and make coffee rich in oil. One end of the upper pot 102 cover is fixed with at least one nylon cover cap 101, and an other end is hinged with the upper pot body 108 through the nylon cover cap 101 and pins 106. The upper pot cover 102 can be opened or closed by pressing the nylon cover cap 101, which is well insulated and also prevents hands from being burned. The upper pot handle 107 being fixedly connected to one side of the upper pot body. Similarly the upper pot handle 107 is also made of nylon, which is not limited to nylon, and can be replaced with other suitable thermal insulation materials.

In other specific embodiments of the present invention, other aspects are the same as the above embodiments, except that as shown in FIGS. 2 and 3, the main body 202 is cylindrical, an upper part of the main body 202 is formed with an accommodating space 205, the coffee powder hopper 7 is snapped in the accommodating space 205 when assembled, and the coffee powder hopper 7 is placed on the main body of the heat-dissipating thermostat 2, which results in an overall structure being compact with a reasonable spatial layout. A top of the coffee powder hopper 7 is provided with a filter screen 5 prevent insufficiently extracted coffee powder from entering the upper pot. The main body 202 is threaded with the upper pot 1 and an upper sealing ring 6 is installed between the main body 202 and the upper pot 1 to ensure sealing. The side of the main body is provided with a thermostat handle 201, which is set up for easy gripping and is made of nylon, providing good thermal insulation and preventing hands from being burned, and is not limited to a use of nylon material, but can be replaced with other suitable thermal insulation materials.

In other specific embodiments of the present invention, other aspects are the same as the above embodiments, except that as shown in FIGS. 3 and 4, the top of the water suction hopper 9 is formed with two layers of walls, an outer hopper wall 902 and an inner hopper wall 901, the outer hopper wall 902 is provided with threads, the bottom of the main body 202 is provided with peripheral lower threads 207 and concave internal threads 208, the lower threads 207 of the main body are connected with the lower pot 4, and the main body 202 is connected with the water suction hopper 9 through the internal threads 208; a sealing ring groove is formed between the lower threads 207 and the internal threads 208, and a lower sealing ring 8 is arranged in the sealing ring groove.

The water suction hopper 9 has two layers of walls, forming a double-layer sealing structure, which strengthens sealing, and meanwhile achieves an excellent sealing effect by being equipped with the lower sealing ring 8.

In other specific embodiments of the present invention, other aspects are the same as the above embodiments, except that as shown in FIGS. 1 and 2, an inner portion of a lower pot 4 is used as a water holding tank, and a pot body is provided with a safety relief valve 3, which can safely relieve the pressure inside the coffee pot, and is safe to use.

Based on the above embodiments, working process and principles of the present invention are as follows:

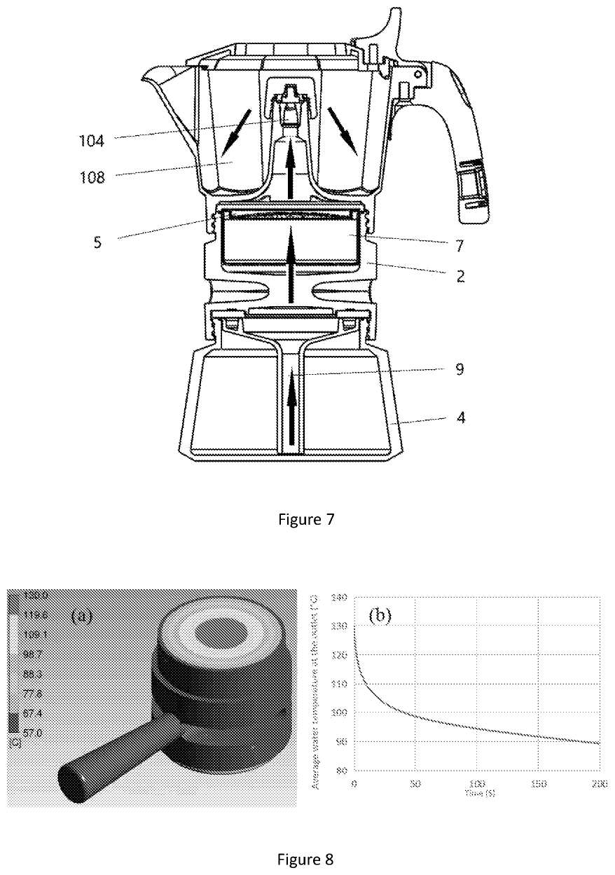

As shown in FIGS. 5 and 7, the coffee powder is placed in the coffee powder hopper 7, the lower pot 4 holds an appropriate amount of water, the coffee pot begins to heat up, and the water in the lower pot 4 turns into steam, and the water flows upwardly from the water suction hopper 9 using steam pressure to come into contact with the heat-dissipating thermostat 2. Since the heat-dissipating thermostat is provided with heat-dissipating grooves 203, the contact surfaces between the main body of the heat-dissipating thermostat and the air is increased. During a period when the hot water passes through the deflector holes 204, the external air fully cools and dissipates the hot water, allowing the water temperature to reach ideal extraction temperature, and then flows out from the upper part of the deflector holes 204, contacts the coffee powder through small holes at the bottom of the coffee powder hopper 7 to form coffee liquid, and then passes through the filter screen 5 to enter the conduit of the upper pot, and then flows out from a booster valve.

The above embodiments are only preferred embodiments of the present invention, and are specifically by no means limited thereto. It will be apparent to those skilled in the art that targeted adjustments can be made based on actual requirements, resulting in different implementations. Since there are many possible ways of implementation, no further examples will be given here.

What is claimed is:

1. A heat-dissipating thermostatic coffee pot comprising an upper pot, a coffee powder hopper arranged in the upper pot, a lower pot and a water suction hopper arranged in the lower pot, wherein a heat-dissipating thermostat is provided between the upper pot and the lower pot, the heat-dissipating thermostat comprising a main body, at least one deflector hole and at least one heat-dissipating groove; the main body is provided with an upper connecting end and a lower connecting end, which are connected to the upper pot and the lower pot, respectively; the deflector hole comprises a through-hole passing through an upper end and a lower end of the main body; the heat-dissipating groove is arranged on a side of the main body and is placed on an outer periphery of the deflector hole; a conducting water flow path is formed between the lower pot, the water suction hopper, the deflector hole, the coffee powder hopper and the upper pot.

2. The heat-dissipating thermostatic coffee pot according to claim 1, wherein the heat-dissipating thermostatic coffee pot is configured with a plurality of deflector holes circumferentially distributed around a center of the main body and heat-dissipating grooves provided on the side of the main body corresponding to each deflector hole.

3. The heat-dissipating thermostatic coffee pot according to claim 2, wherein the deflector holes are three in number and are distributed at a spacing of 120 degrees along the center of the main body, and the heat-dissipating grooves are three in number with each corresponding to the three deflector holes provided on the side of the main body.

4. The heat-dissipating thermostatic coffee pot according to claim 2, wherein each of the deflector holes is provided with a plurality of heat-dissipating grooves arranged in parallel on the side of the main body.

5. The heat-dissipating thermostatic coffee pot according to claim 1, wherein the heat-dissipating grooves extend from an outer peripheral end to the center of the main body, with diameters of the heat-dissipating grooves gradually decreasing from an outer end to an inner portion.

6. The heat-dissipating thermostat provided by the heat-dissipating thermostatic coffee pot according to claim 1, wherein heights and the diameters of the heat-dissipating grooves are proportional to a capacity of the lower pot.

7. The heat-dissipating thermostatic coffee pot according to claim 1, wherein the upper pot comprises an upper pot body, an upper pot cover, a pressurizing valve cap, a pressurizing valve core and an upper pot handle; the center of the upper pot body being provided with at least one conduit communicating with a bottom, and the conduit being surrounded by a space for holding coffee liquid; the pressurizing valve core being mounted at a top outlet of the conduit and provided with a valve core sealing ring, and the pressurizing valve cap being installed on the pressurizing valve core; one end of the upper pot cover being fixed with at least one nylon cover cap, and another end being hinged with the upper pot body through the nylon cover cap and pins; the upper pot handle being fixedly connected to one side of the upper pot body.

8. The heat-dissipating thermostatic coffee pot according to claim 1, wherein the main body is cylindrical, an upper part of the main body is formed with an accommodating space, the coffee powder hopper is snapped in the accommodating space, a top portion of the coffee powder hopper is provided with a filter screen, the main body is threaded with the upper pot, and an upper sealing ring is installed between the main body and the upper pot; and a thermostat handle is provided on the side of the main body.

9. The heat-dissipating thermostatic coffee pot according to claim 1, wherein the top of the water suction hopper is formed with two layers of walls, an outer hopper wall and an inner hopper wall, the outer hopper wall is provided with threads, the bottom of the main body is provided with peripheral lower threads and concave internal threads, the lower threads of the main body are connected with the lower pot, and the main body is connected with the water suction hopper through the internal threads; a sealing ring groove is formed between the lower threads and the internal threads, and a lower sealing ring is arranged in the sealing ring groove.

10. The heat-dissipating thermostatic coffee pot according to claim 1, wherein an inner portion of a lower pot body is used as a water holding tank, and a pot body is provided with a safety relief valve.

11. The heat-dissipating thermostatic coffee pot according to claim 2, wherein the heat-dissipating grooves extend from an outer peripheral end to the center of the main body, with diameters of the heat-dissipating grooves gradually decreasing from an outer end to an inner portion.

12. The heat-dissipating thermostat provided by the heat-dissipating thermostatic coffee pot according to claim 2, wherein heights and the diameters of the heat-dissipating grooves are proportional to a capacity of the lower pot.

13. The heat-dissipating thermostatic coffee pot according to claim 2, wherein the upper pot comprises an upper pot body, an upper pot cover, a pressurizing valve cap, a pressurizing valve core and an upper pot handle; the center of the upper pot body being provided with at least one conduit communicating with a bottom, and the conduit being surrounded by a space for holding coffee liquid; the pressurizing valve core being mounted at a top outlet of the conduit and provided with a valve core sealing ring, and the pressurizing valve cap being installed on the pressurizing valve core; one end of the upper pot cover being fixed with at least one nylon cover cap, and another end being hinged with the upper pot body through the nylon cover cap and pins; the upper pot handle being fixedly connected to one side of the upper pot body.
